(19) United States
(12) Patent Application Publication
(10) Pub. No.: US 2017/0129346 A1
(43) Pub. Date: May 11, 2017

(54) MONOPHASE-INVERTER

(71) Applicant: WINSLIM, Luxembourg (LU)

(72) Inventor: Jean-Yves GASPARD, Gleize (FR)

(21) Appl. No.: 15/128,783

(22) PCT Filed: Mar. 25, 2015
(86) PCT No.: PCT/EP2015/056336

§ 371 Date: Sep. 23, 2016

(30) Foreign Application Priority Data
Mar. 25, 2014 (FR) 14 52489

(51) Int. Cl. B60L 11/18; H05B 6/06; H05B 6/10; H02J 3/38; H02M 7/44

(52) U.S. Cl. CPC B60L 11/182; H02J 3/385; H02M 7/44; H05B 6/108; H05B 6/06

(57) ABSTRACT

A supply device for inductive installation includes an inverter supplying at least one inductor. The supply device also includes at least two power supply inputs, each capable of being connected to a different energy source, the inverter configured to transform an input current derived from one of the at least two energy sources and an output current, and a switching unit that switches from one power source to another. The supply device makes it possible to benefit from several power sources without making the inductor power circuit complex. Consequently, the output remains high.

### TECHNICAL FIELD OF THE INVENTION

The present invention relates to inductive energy transfer systems such as induction heating systems, for example, or inductive battery charging systems, with these examples being non-limiting.

These inductive energy transfer systems comprise energy converters such as inverters, which are fed by the power supply grid, also known as the mains and which transform this energy into electric or thermal energy for its delivery to systems.

The invention relates to converters with multiple inputs and which are capable of taking energy preferentially on ancillary inputs rather than on the power supply grid. The energy source for the ancillary inputs may in particular be photovoltaic, wherein the system preferentially selects an input energy source rather than another, depending on its setting.

### STATE OF THE ART

Inductive energy transfer systems generally comprise a power supply, such as the AC mains, which is rectified and filtered and supplies at least one energy converter such as an inverter.

The most common domestic systems are induction hotplates. Induction hotplates comprise an inverter, preferentially a resonant inverter, which supplies an inductor. The inductor has an inductance L with which one or several capacitors C can be combined, thereby forming a circuit resonating at a frequency f=1/(2π√(L.C′)), generally around 20 kHz.

A cooking utensil, preferentially ferromagnetic, placed on the inductor is exposed to the alternating field at the frequency f of the latter and is subject to induced currents, so-called eddy currents, thereby resulting in its heating.

This system offers many advantages:
Very easy power adjustment by controlling the resonant inverter.
High operational dynamics owing to the fact that the energy is dissipated directly in the load.
High output for the same reason.
Precise electronic temperature control and high power possible, contributing to the success of these technologies.

Other mass-market, therefore high potential volume applications are beginning to emerge, such as inductive energy transfer or induction water heaters.

Inductive energy transfer is based on a similar principle, i.e. the container placed on the inductor is replaced by a second inductor, thereby forming a High Frequency (HF) transformer allowing secondary recovery of electrical energy.

The transferred energy can of course be used for other purposes, such as wireless electric power supplies of mobile devices, camping vans, market stall power supplies, etc., wherein the wireless system offers many advantages, including in particular galvanic insulation, ensuring a high level of operating safety in an outdoor environment.

The technology of induction water heaters is more recent, with induction allow, in the same manner as in cooking hotplates, high heating power while retaining optimum power density for energy transfer, high dynamics, precise power adjustment and above all in the case of a water heater, insensitivity of the inductor to limescale: since the inductor is not longer the heating element, it is no longer affected by boiler scale deposits, as may be the case with a resistor that is immersed or inside a sheath.

Induction water heaters are also an answer to the advent of new energies of the so-called intermittent type, such as wind or solar power, the production of which is not mastered. It is indeed possible to communicate with the inverter control system in order to indicate which energy is available to the latter in real time. This allows reconciliation of use and production, which represents a major handicap with these energies. This is of course also made possible by the fact that a water heater is a daily storage system, in which the time of heating and power of heating is not fundamental to its correct operation, the essential aspect being availability of sufficient daily energy for hot water production. Since domestic hot water is usually drawn on a regular basis, the control systems of the inverters can be equipped with anticipation or even learning programs, whereby drawing of water, the data of which is easily related to the changes in the temperature sensors located in the tank or on the outlet pipes, is also easily recordable on a daily or weekly basis.

Induction systems designated “combination” systems featuring several have also recently become known from WO-A1-2014026879. This means in fact that a same type of generator is used for several applications, including for example non-restrictively, the three aforementioned applications, i.e. induction hotplates, induction water heaters and induction recharging of vehicles. For a 16A-230V inverter, i.e. with a maximum power of 3700W, the period of use of an induction hotplate is half an hour per day on average. The period of use of a water heater is two hours per day on average. The average charging time of an electric vehicle is four hours per day (slow ½ charge). It is therefore possible and wise to use one and the same inverter for these applications, or indeed for others, with applications requiring immediate use of the inverter taking precedence (cooking) over so-called storage applications. The inverter is thus assigned cyclically to different loads allowing cooking at lunchtime, heating water in the afternoon in order to absorb the intermittent energy and charging a vehicle overnight, with this example being merely illustrative with respect to the appliances and moments of use and loads of these appliances.

These “combination”-type devices have the disadvantage of not fully optimising the user's electricity consumption. No solution is in fact offered for use of green energy sources in order to fully optimise the user's electricity consumption.

Ultimately, the problems of so-called green energies of the photovoltaic type lies in the difficulty in matching electricity production and use. The fact is that a photovoltaic panel will only produce electricity in sunny weather. It is therefore impossible to reconcile demand and supply of energy under these circumstances. Although WO-A1-2014026879 suggests optimising a water heater's electricity consumption, the latter remains bound to a fixed means of supply which, in the case of a mains power supply, is available at all times and in the case of supply by green energy, is intermittent.

Furthermore, systems using two separate supply sources are known from the state of the art, for example GB2492342, one for instance derived from photovoltaic panels and the other from an alternating voltage source, wherein one or both of the sources may display power fluctuations over time. It is known in this case to use either energy source in parallel with the other in order to compensate for the power fluctuations. In this type of configuration, an external maximum power point tracking (MPPT) module comprising logic circuits is used at the output of the photovoltaic panels in order to maximise their yield.

Intermittent energy sources (photovoltaic, turbine: wind-powered, hydraulic) are developing in medium-power plants and also in domestic use. A private user may also equip his/her roof, or any other surface on which the sun is able to shine, with photovoltaic panels. These panels are directly or indirectly connected to an inverter, the role of which is firstly to manage the variable energy generated by the panels (MPPT) and secondly to shape the DC current produced by the panels into a 50 Hz (or 60 Hz depending on the country) alternating signal allowing local use of this energy by standard appliances or allowing synchronisation at the level of electric power distribution in order to resell this electricity production. Furthermore, significant advances are under way in improving the output of the photovoltaic panels, making this green energy source one of the most accessible to private individuals.

The present invention offers an improvement in energy management of an inductive energy transfer system of the induction water heater type by way of a non-restrictive example. In an inventive manner, it proposes use of only one single inverter capable of interacting with at least two different energy sources, at least one of which is a green energy source.

### SUMMARY OF THE INVENTION

According to one aspect, the invention relates to a supply device for inductive installation comprising an inverter supplying at least one inductor and:
It comprises at least two power supply inputs, each capable of being connected to a different energy source.
It comprises only one single inverter configured in order to transform an input current derived from one of the at least two energy sources and an output current.
It comprises means of switching from one power source to another.

Hence, the invention makes it possible to benefit from several power sources without making the inductor power circuit complex. Consequently, the output remains particularly high.

According to another aspect, the invention relates to a water heating device comprising a heating unit designed to contain a volume of water, an inductive load arranged so as to heat the volume of water and a device described by the above aspect configured such that the inductor generates an induced current in the load.

Finally, according to another aspect, the invention concerns an installation comprising at least two energy sources and either of the devices described by the above two aspects of the invention.

According to one embodiment, the invention is a supply device for inductive installation comprising an inverter supplying at least one inductor and comprising:
A power input. This advantageously single power input is configured for a direct voltage power source, derived for example from photovoltaic panels.
only one single inverter configured in order to transform an input current derived from an energy source and an output current.

Hence, only one single inverter serves as a photovoltaic inverter and as an inductive energy transfer inverter.

According to another aspect, the present invention also relates to a battery charging device for an electric and/or hybrid vehicle comprising a battery, a charger, a secondary inductive device capable of interacting with the charger and a device according to the present invention for which the inductor generates an induced current in the secondary inductive device.

According to another aspect, the present invention relates to an installation comprising at least two energy sources and a device according to the present invention.

### BRIEF DESCRIPTION OF THE FIGURES

The goals and objectives as well as the characteristics and advantages of the invention will better emerge from the detailed description of an embodiment of the latter which is illustrated by the following appended drawings wherein:

FIG. 1 shows the general principle of the present invention;

FIG. 2 shows a detailed wiring diagram of the present invention;

FIG. 3 shows an operating diagram of the present invention.

The drawings appended herein are given as examples and are not limiting to the invention. These are schematic drawings intended to facilitate the understanding of the invention and are not necessarily at the same scale of the practical applications.

### DETAILED DESCRIPTION OF THE INVENTION

It should be noted that, within the scope of the present invention, the definition of the terms “set point”, “setpoint” or their equivalents is a temperature level configurable by a user. A means of supply corresponds to this temperature setpoint, in the non-restrictive case of use of the present invention to supply a water heater.

It should be noted that, within the scope of the present invention, the definition of the term “mains” or its equivalents is a source of AC current emitting a signal with regular electrical parameters, derived from a network, for example a 230 V signal at a frequency of 50 Hz, obtained from a national grid.

Preferably, the term “mains” or its equivalents includes a source of AC current delivered by a non-transportable installation generating electricity, for example a nuclear power plant.

Advantageously, the term “mains” or its equivalents includes a source of AC current supplied via a public mains grid intended for domestic use for example.

It should be noted that, within the scope of the present invention, the definition of the term “green energy”, “intermittent energy” and “renewable energy” or their equivalents is energy derived from a system of solar panels, wind energy and/or any other type of energy other than the mains and in particular, not displaying the same regularity over time.

Inductor 101 means an element for inductive energy transfer. Typically, this element may comprise a winding capable of generating a magnetic field. The inductor 101 is designed to interact with a load such as a material displaying electrical conductivity in which the induced current generates heating or furthermore a secondary winding.

Switch means a device allowing toggling from one energy source to another. In the present invention and in the case of two energy sources, a switch is also known as a changeover relay.

Before going into the details of the preferred embodiments, more particularly with reference to the figures, different options that the invention may display preferentially but not restrictively, wherein these options may be implemented either alone or in any combination, are enumerated hereunder:

Advantageously, the means of switching comprise means of control allowing switching between at least two operating modes: a mode adapted to an alternating voltage power source 300 and a mode adapted to a direct voltage power source 200.

The existence of an operating mode specific to each supply mode allows optimisation of the energy delivered by each power source.

Advantageously, the means of control comprise a maximum power point tracking (MPPT) module 600 communicating with a central processor 800 for controlling the inverter 100 when the present invention is switched to the operating mode adapted to a DC photovoltaic power source 200.

In order to maximise the power available at the photovoltaic panels, the central processor 800 uses an MPPT module 600.

Advantageously, the maximum power point tracking (MPPT) module 600 uses a Disturbance and Observation algorithm.

This is an algorithm based on the trial/error principle. Continuously, when the operating mode involves the energy of the photovoltaic panels, the MPPT module 600 modifies the frequency of the inverter 100 and measures the power thus obtained so as to maximise the latter.

Advantageously, the present invention comprises, for a direct voltage power source 200, an electromagnetic compatibility (EMC) filter 201.

Advantageously, the present invention comprises, for a direct voltage source 200, a direct voltage (DC) switch 500.

This DC switch 500 allows the central processor 800 to switch to the direct voltage power source 200.

Advantageously, the direct voltage switch 500 features a control module 502.

This control module 502 allows a test of the power available at the photovoltaic panels 200 before and during each switching to the direct voltage power source 200.

Advantageously, the means of control govern the direct voltage switch 500 of the direct voltage power source 200 via a relay control 501.

The relay control 501 allows control of the switch 500 by the central processor 800.

Advantageously, the present invention comprises, for the alternating voltage power source 300, an alternating voltage (AC) switch 400.

This AC switch 400 allows the central processor 800 to switch to the alternating voltage power source 300.

Advantageously, the means of control are configured to govern the alternating voltage switch 400 of the alternating voltage source 300 via a relay control 401.

The relay control 401 allows control of the AC switch 400 by the central processor 800.

Advantageously, the present invention can be applied to a water heating device comprising a heating unit designed to contain a volume of water, an inductive load arranged so as to heat the volume of water and the present invention configured such that the inductor 101 generates an induced current in the inductive load.

Advantageously, the means of control are configured in order to:
Apply a first temperature setpoint, known as the AC setpoint, for water heating in the mode adapted to an alternating voltage power source 300.
Apply a second temperature setpoint, known as the DC setpoint, for water heating in the mode adapted to a direct voltage power source 300.

Wherein the second setpoint is greater than the first setpoint.

Advantageously, the means of switching are configured over at least one timeframe predetermined in order to switch to:
the direct voltage supply mode from an available power threshold on input corresponding to the direct voltage power source 200.
the alternating voltage supply mode below said power threshold.

This first timeframe corresponds to the daylight hours of the day. Hence, the central processor 800 is able to test within this timeframe the power available at the photovoltaic panels 200.

Advantageously, the means of switching are configured over at least a second timeframe predetermined in order to switch to the alternating voltage supply mode 300.

This second timeframe corresponds to the night-time hours. Consequently, the central processor 800 does not attempt to perform a power test on the photovoltaic panels 200 during the night.

Advantageously, the present invention can find an application in an installation comprising at least two energy sources and a water heating device comprising a heating unit designed to contain a volume of water, an inductive load arranged so as to heat the volume of water and the present invention configured such that the inductor 101 generates an induced current in the inductive load.

Advantageously, one of the power sources is a so-called “green” energy source.

Use of green energy allows a substantial financial saving for the user.

Advantageously, one of the two power sources is photovoltaic solar energy source 200.

The user can easily arrange photovoltaic panels on the roof of his/her house for example in order to take advantage of this free energy source.

Advantageously, one of the power sources is power source of the “mains” type 300.

Use of the mains as the second power source is necessary, since the second power source is a so-called intermittent source.

Advantageously, one or several optocouplers 503 is/are present in the direct voltage switch 500.

Use of optocouplers 503 allows galvanic isolation of the DC switch 500 and the central processor 800.

Advantageously, an opto-isolated connection 504 is present between the direct voltage switch 500 and a central processor 800.

This connection allows communication between the DC switch 500 and the central processor 800 and moreover without galvanic contact.

Advantageously, the central processor 800 has a clock indicating the date and time.

This clock allows the system to tell the date and time and consequently know the day and night hours, in addition to the theoretical sunshine periods.

Advantageously, the inverter 100 sends data to the central processor 800.

In order to control the inverter, the central processor 800 needs data concerning the status of the inverter 100.

Advantageously, the inverter 100 sends power measurements to the central processor 800.

The power data are necessary so that the MPPT 600 can be used by the central processor 800 for controlling the inverter 100.

Advantageously, the inverter 100 sends current measurements to the central processor 800.

Advantageously, the inverter 100 sends voltage measurements to the central processor 800.

Advantageously, the inverter 100 sends phase measurements to the central processor 800.

Advantageously, a user interface allows a user to select the operating modes of the device and parametrise the latter.

Advantageously, one of the two power sources is photovoltaic solar energy source 200.

Advantageously, one of the power sources is a mains power source 300.

Advantageously, the central processor 800 has a climate forecast data input.

Using a meteorological data module can allow the central processor 800 to optimise its operation and be able to predict and anticipate future periods of sunshine in case of use of photovoltaic panels 200 as the direct voltage power source.

Advantageously, an automatic supply mode favouring the green energy source is available.

The user may if s/he wishes solely use the direct voltage power source 200 in order to make savings or if his/her circumstances do not allow this, use the mains as the power source.

According to one embodiment, the present invention has two power sources: A direct voltage source 200, for example photovoltaic panels and an alternating voltage source 300, the mains for example. The present device is configured such as to be able to select the type of power source to be used depending on user parameters or predetermined parameters.

In one embodiment, the present invention provides several operating modes: A fixed mode and an automatic mode.

The fixed mode corresponds to a system configuration according to which a single energy source is used. Consequently, the supply mode is fixed. For example, non-restrictively, the user may decide to use only the photovoltaic panels 200 as the power source, regardless of the available sunshine, or conversely, the system can be fixed on the mains power source 300.

Automatic mode corresponds to a system configuration according to which, for example non-restrictively, solar mode is activated by default. According to this operating mode, the inverter 100 transfers to active mode and the system subsequently attempts to reach the DC setpoint temperature, specific to the mode of supply with direct voltage derived from the photovoltaic panels 200, previously configured by the user or predetermined. If the setpoint cannot be reached owing to insufficient available power in terms of solar energy and if the deviation between the setpoint and the current measurement exceeds a value predetermined by the user in the system, the system switches to alternating voltage supply mode, on the mains 300, in order to allow the system to reach the AC temperature setpoint specific to the alternating voltage supply mode defined by the user or predetermined. This AC temperature setpoint is different from the DC temperature setpoint. The AC temperature setpoint is less than the DC temperature setpoint.

According to a particularly advantageous embodiment, the present invention uses one single energy source at a time. Switching from one energy source to another is in all or nothing mode. Therefore, in a first case, 100% of the energy used by the system is derived from the mains energy source and 0% is derived from the photovoltaic panels; in a second case, 100% of the energy used by the system is derived from the photovoltaic panels and 0% is derived from the mains energy source.

If there is daylight but no photovoltaic energy is available and the water temperature in the water heater is below the AC setpoint, the system will derive its energy from the conventional electricity network, the mains. Since however the heat-up time is generally long, the system will periodically test the photovoltaic source in order to ascertain whether the green energy is available. According to one embodiment, the system can memorise the responses to the successive power tests and deduce a type of sunlight before adapting accordingly the periodicity of the tests on the photovoltaic source.

According to one embodiment, the device features one or several forecast data inputs allowing advance assessment of at least one environmental parameter such as temperature, sunlight or wind, by way of non-restrictive examples. Hence, the device adapts to the environment and configures its settings as a function of the climatic conditions in order to maximise the available power and attenuate at least some meteorological impacts on its operation that may be detrimental to the user.

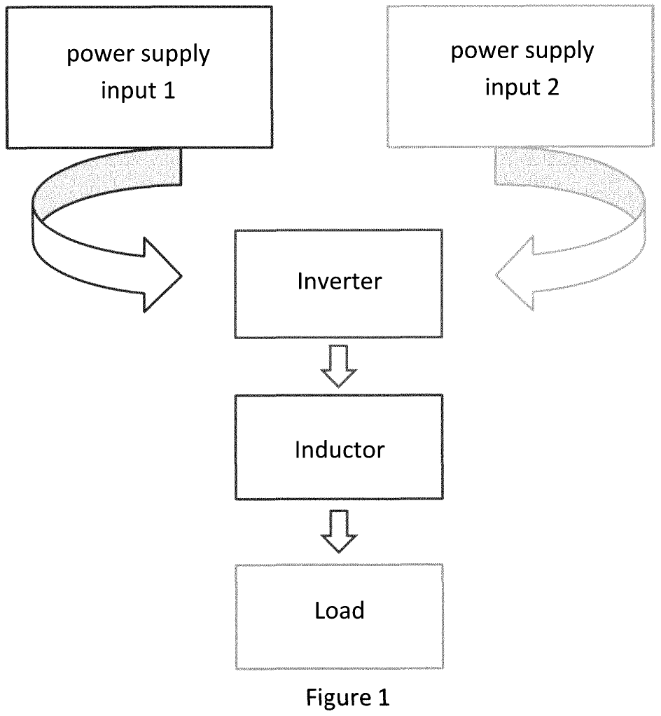

FIG. 1 shows, according to one non-restrictive embodiment, the block diagram of the present invention. Two energy sources: Source 1 and Source 2 are connected to a single inverter. An inductive system is then connected at the inverter output. Energy transfer subsequently occurs between the inductor and the load. The inverter has the specific feature of being able to toggle between one power source and another depending on its operating mode and/or the user parameters. Furthermore, according to one embodiment, one or both current sources may be a source of direct voltage and/or alternating current.

Advantageously, the inverter switches completely from one energy source to another so as to use only a single energy source at a time.

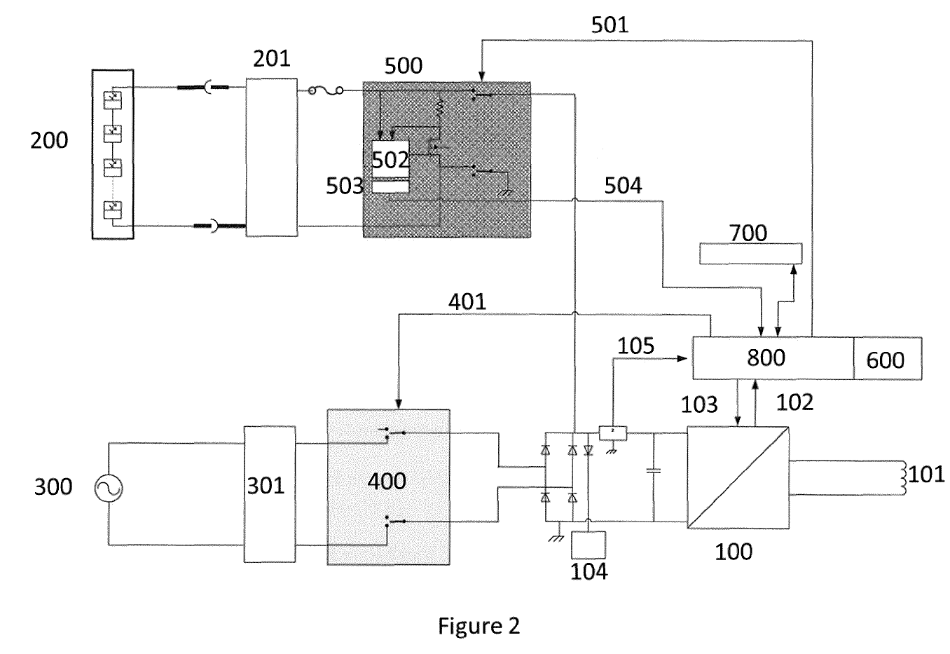

FIG. 2 shows, according to one embodiment and by way of a non-restrictive example, the electric circuit diagram of the present invention. According to this embodiment, a single inverter 100 is connected to two energy sources: a direct voltage source 200 obtained from photovoltaic panels and an alternating voltage source obtained from the power supply grid, the mains 300.

The direct voltage source formed by the photovoltaic panels is connected to the inverter by means of several elements. First of all, an electromagnetic compatibility (EMC) filter 201 allows satisfactory use of the photovoltaic panels 200 in their electromagnetic environment, without producing electromagnetic disturbances themselves for the surrounding items of equipment.

Next, the EMC 201 is connected in parallel to a direct voltage switch (DC switch) 500 capable of comprising a control module 502. The control module 502 ensures monitoring of the power available at the photovoltaic panels so that switching of the system to this green energy source is performed under useful power conditions for supply of the induction device. Finally, the DC switch 500 may have one or several optocouplers 503 allowing opto-isolation of the DC switch 500, by a connection 504, from the central processor 800. Consequently, the DC switch 500 is connected to the central processor 800 by a non-galvanic contact. Finally, a relay control 501 is used to govern the DC switch 500 from the central processor 800 of the device managing all the functions.

According to the invention, the inverter 100 is the only inverter present in the circuit, from the photovoltaic panels to the inductor and mutatis mutandis from the mains to the inductor.

The second energy source is the mains 300 connected to the system via various modules including an EMC filter 301, allowing satisfactory use of the mains in its electromagnetic environment, without producing electromagnetic disturbances itself for the surrounding items of equipment. Next, an alternating voltage switch (AC switch) 400 is connected in parallel to the EMC 301. This AC switch 400 is controlled by the central processor 800 via a connection 401 serving as a relay control.

Subsequently, the DC switch 500 and the AC switch 400, both of which are connected to the inverter 100. At the level of this connection, a measurement of the current intensity is performed by the central processor 800 via the connection 105. The inverter 100 is also connected to an inductor 101 and to the central processor 800 via the connections 103 and 102. The connection 102 makes it possible to send to the central processor 800 the data concerning the current, voltage and phase of the electrical signal, in addition to the temperature at the inductor 101. In return, the central processor 800 sends back a pulse width modulation (PWM) signal 103. This signal subsequently allows frequency control of the inverter 100.

Advantageously, control of the inverter by the central processor 800 is performed by a change in its operating frequency.

Finally, the central processor 800 has a maximum power point tracking (MPPT) module 600 allowing, in the case of use of the direct voltage source, control of the frequency of the inverter via the central processor 800 in order to maximise the available power by a measurement of the voltage and of the current, thereby adjusting the frequency of the inverter 100 via the PWM connection 103. The MPPT system 600 operates, for example, according to an algorithm of the Disturbance and Observation (D&O) type. This algorithm involves seeking a maximum power point by trials/errors. Indeed, the system attempts to reach the maximum power point starting from a high inverter frequency and by gradually reducing the latter via the PWM connection 103, measuring the voltage and current via the connection 102 in order to calculate the power. Hence, the MPPT module 60 is configured in order to allow the central processor 800 to control the inverter 100 in order t maximise the power delivered by the inverter 100 and not that delivered by the photovoltaic panels as commonly encountered in the prior art.

According to a particularly advantageous embodiment, the MPPT module 600 is a computer program configured to be used by the central processor 800 in order to control the inverter 100 with the purpose of maximising the power delivered by the inverter 100. Use of an MPPT module 600 of the computer program type affords a high level of adaptability of the present invention to all types of energy source. Indeed preferentially, the central processor 800 is able to assess, automatically for example, the type of energy source currently used by the system and adapt said inverter 100 accordingly.

Thus, preferentially, the MPPT module 600 can be activated if the central processor 800 detects power variations at the inverter 100 by the power measurement 102 provided by the latter, advantageously for an input of a continuous electrical signal. These power variations may be related for example to use of a renewable energy source, such as photovoltaic panels. Conversely, the MPPT module 600 can be deactivated if the power measured at the output of the inverter 100 is constant over time.

Advantageously and according to a preferential embodiment, the present invention allows use of a single inverter 100 capable of being adapted in frequency to all types of energy source to which it may be connected in order to optimise its electric power output.

The algorithm can be implemented in a computer program stored itself in a memory and readable in the form of instructions by at least one processor. Preferentially, the algorithm is integrated in the microprocessor.

Finally, the entire system is configurable and controllable by an interface 700 comprising, for example non-restrictively, a touchscreen or standard screen and a real or virtual keyboard. Via this interface, the user is able to determine his/her chosen uses: for example “comfort” in which priority is given to the AC setpoint for hot water or “eco” in which a minimum of mains energy is used, even if this involves having less hot water available if production of photovoltaic energy has been low.

The invention is applicable to an energy storage device such as for water heating. Water heaters are devices allowing heating of water for various different household or industrial requirements. A water heater means a water accumulation appliance having at least one tank serving as a heating unit for storing hot water, also often known as a cylinder, wherein the tank is the location at which the water is heated, wherein the tank is frequently called the heating unit or cylinder. The capacity of said tank is differs in volume depending on the requirements for which the accumulation appliances are intended, being for instance associated with a tap or taps of a washbasin, shower and/or a bath, etc.

The present invention has an application in induction water heaters. This type of water heater comprises a heating unit and an induction heating device, including a power generator and an inductive module comprising at least one inductor and at least one load, wherein the at least one inductor is configured in order to generate an induced current in the load, characterised in that said at least one inductor and at least one load are arranged immersed in the heating unit. The technical effect is to guarantee a direct heat exchange between the inductive module formed of an inductor and of at least one load with the water contained in the water heater. The inevitable heating of the inductor, resulting in losses, is recovered and also serves to heat the water contained in the water heater.

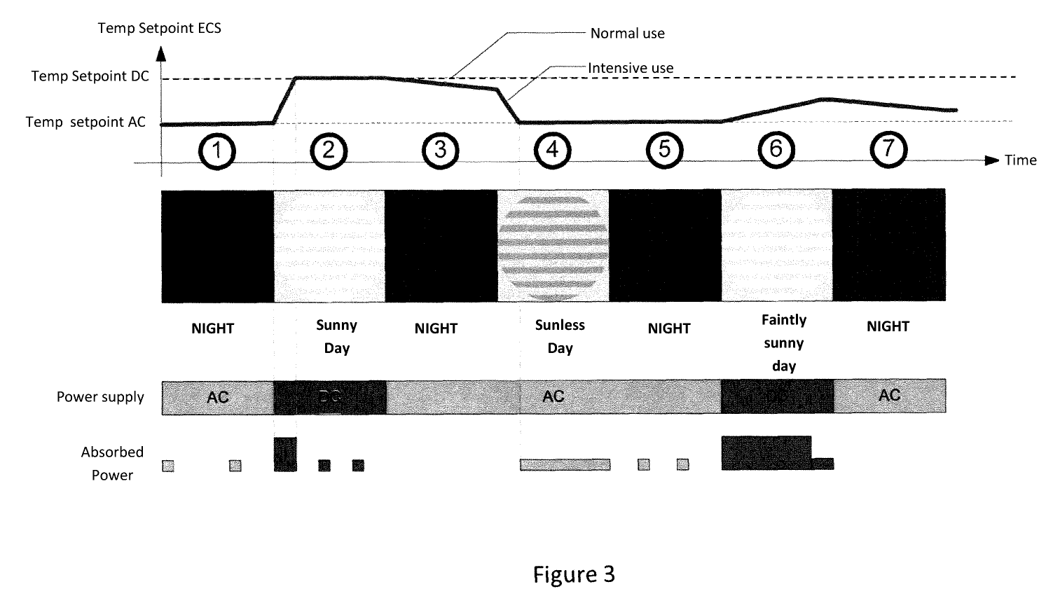

FIG. 3 shows, according to one embodiment, an example of use of the present invention in water heater mode with two energy source inputs and two different temperature setpoints corresponding to each of the energy sources. Hence, a temperature setpoint corresponds to a supply mode. The setpoint designated as the AC setpoint corresponds to the temperature setpoint when the supply mode is the alternating voltage supply mode. The setpoint designated as the DC setpoint corresponds to the temperature setpoint when the supply mode is the direct voltage supply mode. During each switching operation from one supply mode to the other, the temperature setpoint also changes so that the temperature setpoint matches the supply mode to which the device is switched. According to one embodiment, the AC temperature setpoint is less than the DC temperature setpoint.

FIG. 3 illustrates four nights and three days. By way of an example, the operating mode is indicated as a function of the presence or absence of energy at the photovoltaic panels.

For example, zone 1 represents one night; there is no photovoltaic energy available and the generator is therefore switched to the alternating voltage source, the mains.

In zone 2, which represents a sunny day, the photovoltaic energy is available and is therefore stored in the cylinder. The generator is therefore switched to the direct voltage energy source.

In zone 3, which represents a night, the photovoltaic energy is not available. The energy stored during the daytime is sufficient however to ensure supply of Domestic Hot Water (DHVV) until the following day. The generator is therefore switched to the mains but does not consume any energy; it is on stand-by.

In zone 4, corresponding to a sunless day, since the photovoltaic energy is not available, the generator is switched to the mains for DHW heating.

In zone 5, corresponding to the night, since there is no photovoltaic energy, the generator is switched to the mains.

In zone 6, representing a day when little photovoltaic energy is available, the generator is switched to the direct voltage source. There is not enough energy to reach the setpoint, but enough to provide the DHW required without switching to the alternating voltage energy source.

In zone 7, during darkness, the generator is switched to alternating current.

According to one embodiment, switching between the AC and DC supply modes is controlled by the central processor 800. Management of switching may be based, among other aspects, on time data. The central processor 800 has a clock serving as a calendar and allowing the system to tell the current date and time. This subsequently allows knowledge of the theoretical sunshine hours, for example for use of photovoltaic panels. According to the operating mode selected by the user of the present invention, the central processor 800 may need to be aware of the power available at the photovoltaic panels 200. For this purpose, the central processor 800 has to switch to the direct voltage supply mode and test the power available via the module 502. Depending on the user parameters, if this measured power is sufficient, the central processor 800 remains switched to this power source. If the measured power is insufficient and depending on the user parameters, the central processor 800 switches to the alternating voltage supply mode. In order to optimise the frequency of these power tests at the photovoltaic panels, the central processor 800 refers, according to one embodiment, to its clock. Account is taken of this time data in order to optimise the power test frequency at the photovoltaic panels. At night for example, the central processor 800 will not perform a power test at the photovoltaic panels, since it is informed by its clock that it is dark. Hence, according to one embodiment, part of switching management depends on time parameters. These parameters define for example at least two time spans with different methods of operation, for example day and night.

Hence, the present invention, according to one embodiment, automatically governs, depending on the user settings and time parameters, toggling from one power source to the other in order to maximise the power available and minimise the energy expenditure related to use of the alternating power source, the mains.

According to one embodiment, the invention is a supply device for inductive installation comprising an inverter 100 supplying at least one inductor 101 and comprising:
A single power input. This single power input is configured for a direct voltage power source, derived for example from photovoltaic panels.
only one single inverter (100) configured in order to transform an input current derived from an input electric current and an output electric current;

Hence, only one single inverter serves as a photovoltaic inverter and as an inductive energy transfer inverter.

The invention is not limited to the embodiments described above but applies to all the embodiments covered by the scope of the claims.

### REFERENCES

100. Inverter

101. Inductor

102. Current, Voltage, Temperature and Phase signal

103. Pulse width modulation signal

104. Switched-mode power supply

105. Current measurement

200. Photovoltaic panels

201. Electromagnetic compatibility filter

300. Mains

301. Electromagnetic compatibility filter

400. Alternating voltage (AC) switch

401. Switching signal

500. Direct voltage (DC) switch

501. Switching signal

502. Control

503. Optocouplers

504. Opto-isolated connection

600. Maximum Power Point Tracking software

700. Keyboard and monitoring screen

800. Central processor

1. A supply device for inductive installation comprising an inverter supplying at least one inductor, wherein:
it comprises at least two power supply inputs, each capable of being connected to a different energy source;
it comprises only one single inverter configured in order to transform an input current derived from one of the at least two energy sources in an output current;
it comprises a switch configured to switch from one power source to another, wherein this switch comprises a controller configured to allow switching between at least two operating modes: a mode adapted to an alternating voltage power source and a mode adapted to a direct voltage power source:
said controller comprising a maximum power point tracking module communicating with a central processor for controlling said inverter when the device is switched to the operating mode adapted to the direct voltage power source.

2. The supply device according to claim 1, wherein the maximum power point tracking (MPPT) module uses an algorithm of the Disturbance and Observation type.

3. The supply device according to claim 1, wherein said inverter is frequency controlled by said central processor by sending at least one pulse width modulation (PWM) signal in response to receiving a signal allowing transfer of data concerning the inductor.

4. The supply device according to claim 3, wherein said data concerning the inductor are taken from among the following: current, voltage, phase of the electric signal, temperature.

5. The supply device according to claim 1, comprising, for a direct voltage power source, an electromagnetic compatibility (EMC) filter.

6. The supply device according to claim 1, comprising, for a direct voltage power source, a direct voltage switch.

7. The supply device according to claim 6, wherein the direct voltage switch features a control module.

8. The supply device according to claim 6, wherein the controller governs the direct voltage switch of the direct voltage source via a relay control.

9. The supply device according to claim 1, comprising, for the direct voltage power source, a switch.

10. The supply device according to claim 9, wherein the controller is configured to govern the alternating voltage switch of the alternating voltage source via a relay control.

11. The supply device according to claim 10, configured to operate according to the first energy source or the second energy source.

12. Battery charging device for an electric and/or hybrid vehicle comprising a battery, a charger, a secondary inductive device capable of interacting with the charger and a device according to claim 1 configured such that the inductor generates an induced current in the secondary inductive device.

13. Water heating device comprising a heating unit designed to contain a volume of water, an inductive load arranged so as to heat the volume of water and a device according to claim 1 configured such that the inductor generates an induced current in the inductive load.

14. The water heating device according to claim 13, comprising a supply device for inductive installation comprising an inverter supplying at least one inductor, wherein:
it comprises at least two power supply inputs, each capable of being connected to a different energy source;
it comprises only one single inverter configured in order to transform an input current derived from one of the at least two energy sources in an output current
it comprises a switch configured to switch from one power source to another, wherein this switch comprises a controller configured to allow switching between at least two operating modes: a mode adapted to an alternating voltage power source and a mode adapted to a direct voltage power source:
said controller comprising a maximum power point tracking (MPPT) module communicating with a central processor for controlling said inverter when the device is switched to the operating mode adapted to the direct voltage power source, wherein the controller is configured to:
apply a first temperature setpoint, known as the AC setpoint, for water heating in the mode adapted to an alternating voltage power source;
apply a second temperature setpoint, known as the DC setpoint, for water heating in the mode adapted to a direct voltage power source;
wherein the second setpoint is greater than the first setpoint.

15. The water heating device according to claim 14, in which the switch is configured over at least one timeframe predetermined in order to switch to:
the direct voltage supply mode from an available power threshold on input corresponding to the direct voltage power source;
the alternating voltage supply mode below said power threshold.

16. The water heating device according to claim 14, wherein the switch is configured over at least a second timeframe predetermined in order to switch to the alternating voltage supply mode.

17. The water heating device according to claim 14, wherein a user interface allows a user to select the operating modes of the device and parametrise the latter.

18. Installation comprising at least two energy sources and a device according to claim 12.

19. The installation according to claim 18, wherein one of the two power sources is a photovoltaic solar energy source.

20. The installation according to claim 18, wherein one of the two power sources is a mains power source.
